(19) United States
(12) Patent Application Publication
(10) Pub. No.: US 2010/0118015 A1
(43) Pub. Date: May 13, 2010

(54) PLASMA DISPLAY DEVICE

(76) Inventors: Mitsuhiro Murata, Hyogo (JP); Takuji Tsujita, Osaka (JP); Toshikazu Wakabayashi, Osaka (JP); Hiroshi Asano, Osaka (JP); Masaharu Terauchi, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/597,967

(22) PCT Filed: Apr. 14, 2009
(86) PCT No.: PCT/JP2009/001704

§ 371 Date: Oct. 28, 2009

(30) Foreign Application Priority Data
Apr. 18, 2008 (JP) 2008-108596

(51) Int. Cl. G09G 3/28; G09G 5/00

(52) U.S. Cl. 345/211; 345/60

(57) ABSTRACT

Protective layer of a plasma display panel has base protective layer and particle layer. Base protective layer is formed of a thin film of metal oxide containing at least one of magnesium oxide, strontium oxide, calcium oxide, and barium oxide. Particle layer is formed by sticking, to base protective layer, single crystal particles of magnesium oxide where the peak at 200 to 300 nm is two or more times that at 300 to 550 nm in a cathode luminescence emission spectrum. The panel driving circuit causes initializing discharge for producing wall charge in the first subfield, of a plurality of subfields, causes address discharge for erasing wall charge in address periods of the plurality of subfields, and drives the panel.

### TECHNICAL FIELD

The present invention relates to a plasma display device as an image display device using a plasma display panel.

### BACKGROUND ART A plasma display panel (hereinafter referred to as “panel”), among thin image display elements, allows high speed display and can be easily enlarged, so that the panel becomes commercially practical as a large-screen display device.

The panel is formed by sticking a front plate to a back plate. The front plate has the following elements:
a glass substrate;
display electrode pairs that are disposed on the glass substrate and each of which is formed of a scan electrode and a sustain electrode;
a dielectric layer formed so as to cover the display electrode pairs; and
a protective layer formed on the dielectric layer.
   The protective layer protects the dielectric layer from ion collision and facilitates discharge.

The back plate has the following elements:
a glass substrate;
data electrodes formed on the glass substrate;
a dielectric layer for covering the data electrodes;
barrier ribs formed on the dielectric layer; and
phosphor layers that are disposed between the barrier ribs and emit red, green, and blue lights, respectively.
   The front plate and back plate are faced to each other so that the display electrode pairs intersect with the data electrodes while discharge space is sandwiched, and their periphery is sealed with low-melting glass. Discharge gas containing xenon is filled into the discharge space. Discharge cells are formed in the parts where the display electrode pairs face the data electrodes.

In a plasma display device using the panel having this structure, a gas discharge is selectively caused in respective discharge cells of the panel, ultraviolet rays generated at this time excite red, green, and blue phosphors to emit lights, and thus color display is attained.

A subfield method is mainly used as a method of displaying an image with the plasma display device using the panel. In this method, one field period is formed of a plurality of subfields of a predetermined luminance weight, light emission and no light emission of each discharge cell is controlled to display an image in each subfield.

When the lighting and no lighting of each discharge cell is performed arbitrarily in each subfield, however, significant gradation turbulence of a contour shape, the so-called false contour, can occur in a displayed moving image. A method of suppressing the false contour is disclosed in Patent literature 1, for example. In this method, the false contour is suppressed by displaying gradation by performing the control so that subfields in which the discharge cell undergoes light emission are successively disposed and subfields in which the discharge cell undergoes no light emission are also successively disposed. Such a display method can suppress the occurrence of the false contour, but displaceable gradation is restricted and display of smooth gradation is difficult, disadvantageously.

In order to display smooth gradation, the number of subfields forming one field period is required to be increased. In the above-mentioned subfield method, one field period is formed of a plurality of subfields, and the subfields in which light is emitted are combined, thereby performing gradation display. Each subfield has an initializing period, an address period, and a sustain period. In order to increase the number of subfields forming one field period, an address operation needs to be certainly performed within a short period. For this purpose, a panel capable of being driven at a high speed has been developed, and a driving method and driving circuit for displaying a high-quality image using the feature of the panel have been studied.

The discharge characteristic of the panel largely depends on the characteristic of the protective layer. Especially, in order to improve the electron emission performance and charge retention performance that affect the possibility of the high speed driving, the material, structure, and manufacturing method of the protective layer have been studied widely. Patent literature 2, for example, discloses a plasma display device having the following elements:
a panel having a magnesium oxide layer that is produced by gas phase oxidation of magnesium vapor and has a cathode luminescence emission peak at a wavelength of 200 to 300 nm; and
an electrode driving circuit for sequentially applying a scan pulse to one electrode of each of the display electrode pairs forming all display lines in the address period and applying, to the data electrode, the address pulse corresponding to the display line to be applied with the scan pulse.

Recently, a plasma display device having a large screen and high definition has been demanded, and high image display quality has been also demanded. Thus, in addition to increase of the number of lines, the number of subfields for displaying the smooth gradation needs to be secured. Therefore, the time assigned to the address operation per line is apt to become increasingly shorter. In order to perform certain address operation within the assigned time, a plasma display device is demanded that has a panel allowing stabler and higher speed address operation than that of the conventional art, its driving method, and a driving circuit for achieving it.

[Patent Literature 1] Unexamined Japanese Patent Publication No. H11-305726

[Patent Literature 2] Unexamined Japanese Patent Publication No. 2006-54158

### SUMMARY OF THE INVENTION

The plasma display device of the present invention has a panel and a panel driving circuit. The panel has the following elements:
a front plate having display electrode pairs on a first glass substrate, a dielectric layer for covering the display electrode pairs, and a protective layer on the dielectric layer;
a back plate that faces the front plate and has data electrodes on a second glass substrate; and
discharge cells formed at the positions where the display electrode pairs face the data electrodes.
   The panel driving circuit drives the panel while a plurality of subfields having an address period for causing an address discharge and a sustain period for causing a sustain discharge in the discharge cells are temporally disposed to form one field period. The protective layer has a base protective layer and a particle layer. The base protective layer is formed of a thin film of metal oxide containing at least one of magnesium oxide, strontium oxide, calcium oxide, and barium oxide. The particle layer is formed by sticking single crystal particles of magnesium oxide to the base protective layer. Here, in the single crystal particles, the emission intensity at the peak at 200 to 300 nm is two or more times that at 300 to 550 nm in the cathode luminescence emission spectrum. The panel driving circuit drives the panel by the following processes:
causing initializing discharge for producing a wall charge in the first subfield, of a plurality of subfields;
causing address discharge for erasing the wall charge in the address periods of the plurality of subfields; and
driving the panel.

### BRIEF DESCRIPTION OF DRAWINGS

FIG. 1 is an exploded perspective view showing a structure of a panel in accordance with an exemplary embodiment of the present invention.

FIG. 2 is a sectional view showing a structure of a front plate of the panel.

FIG. 3 is a diagram showing an emission spectrum of single crystal particles of the panel.

FIG. 4 is a diagram showing the relation between discharge delay time and the peak ratio of the emission spectrum of the single crystal particles used in the panel.

FIG. 5 is a diagram showing an electrode array of the panel.

FIG. 6 is a waveform chart of driving voltage applied to each electrode of the panel.

FIG. 7 is a diagram showing an electrode array of a panel in accordance with a second exemplary embodiment of the present invention.

FIG. 8 is a waveform chart of driving voltage applied to each electrode of the panel in accordance with the second exemplary embodiment.

FIG. 9 is a circuit block diagram of a plasma display device in accordance with the first and second exemplary embodiments of the present invention.

FIG. 10 is a circuit diagram of a scan electrode driving circuit and a sustain electrode driving circuit of the plasma display device.

### REFERENCE MARKS IN THE DRAWINGS

10 panel
20 front plate
21 (first) glass substrate
22 scan electrode
22a, 23a transparent electrode
22b, 23b bus electrode
23 sustain electrode
24 display electrode pair
25 dielectric layer
26 protective layer
26a base protective layer
26b particle layer
27 single crystal particle
30 back plate
31 (second) glass substrate
32 data electrode
34 barrier rib
35 phosphor layer
41 image signal processing circuit
42 data electrode driving circuit
43 scan electrode driving circuit
44 sustain electrode driving circuit
45 timing generating circuit
50, 80 sustain pulse generating circuit
60 initializing waveform generating circuit
70 scan pulse generating circuit
100 plasma display device

### DETAILED DESCRIPTION OF PREFERRED EMBODIMENTS

A plasma display device in accordance with an exemplary embodiment of the present invention will be described hereinafter with reference to the accompanying drawings.

### First Exemplary Embodiment

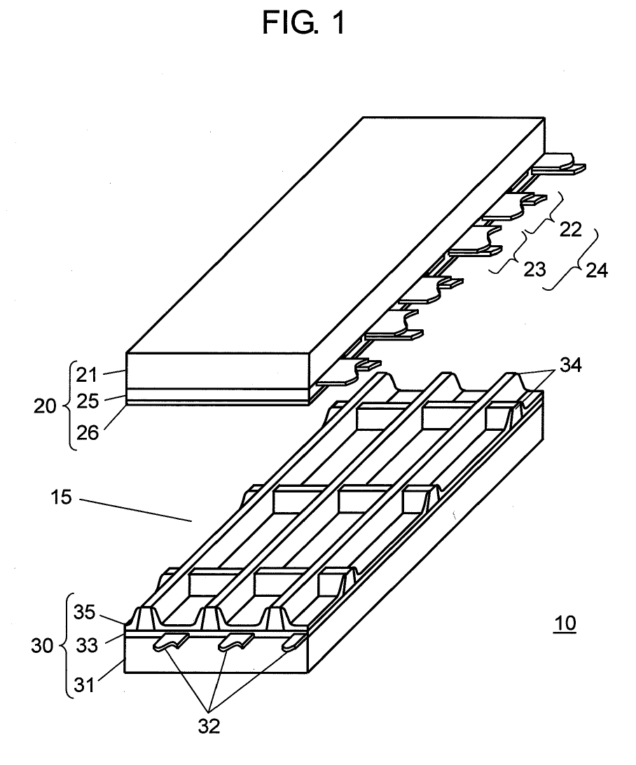

FIG. 1 is an exploded perspective view showing a structure of panel 10 in accordance with a first exemplary embodiment of the present invention. In panel 10, front plate 20 and back plate 30 are faced to each other, and their periphery is sealed with a sealing material made of low-melting glass. Discharge gas such as xenon is filled at a pressure of 400 to 600 Torr into discharge space 15 in panel 10.

A plurality of display electrode pairs 24 each of which is formed of scan electrode 22 and sustain electrode 23 are disposed in parallel on glass substrate (first glass substrate) 21 of front plate 20. Dielectric layer 25 is formed on glass substrate 21 so as to cover display electrode pairs 24, and protective layer 26 mainly made of magnesium oxide is formed on dielectric layer 25.

A plurality of data electrodes 32 are disposed in parallel in the direction orthogonal to display electrode pairs 24 on glass substrate (second glass substrate) 31 of back plate 30, and are covered with dielectric layer 33. Barrier ribs 34 are formed on dielectric layer 33. Phosphor layers 35 for emitting red, green, blue lights with ultraviolet rays are formed on dielectric layer 33 and on side surfaces of barrier ribs 34, respectively. Discharge cells are formed at the positions where display electrode pairs 24 intersect with data electrodes 32, and a set of discharge cells having phosphor layers 35 for red, green, and blue form a pixel for color display. Dielectric layer 33 is not essential, but a structure having no dielectric layer 33 may be employed.

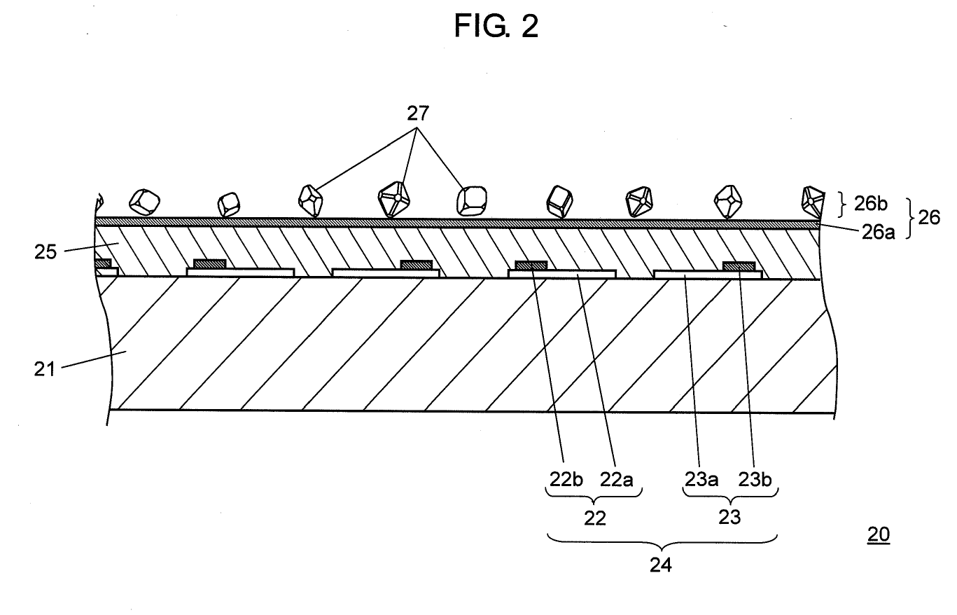

FIG. 2 is a sectional view showing a structure of front plate 20 of panel 10 in accordance with the first exemplary embodiment of the present invention, and is illustrated by turning front plate 20 of FIG. 1 upside down. Display electrode pairs 24 formed of scan electrodes 22 and sustain electrodes 23 are disposed on glass substrate 21. Each scan electrode 22 has transparent electrode 22a made of indium tin oxide or tin oxide, and bus electrode 22b disposed on transparent electrode 22a. Similarly, sustain electrode 23 is formed of transparent electrode 23a, and bus electrode 23b disposed on it. Bus electrode 22b and bus electrode 23b are disposed for applying conductivity in the longitudinal direction of transparent electrode 22a and transparent electrode 23a, and are made of a conductive material mainly containing silver.

Dielectric layer 25 is formed by applying low-melting glass or the like mainly made of lead oxide, bismuth oxide, or phosphorous oxide by screen printing or die coating, and by firing it. Protective layer 26 is formed on dielectric layer 25.

Protective layer 26 is formed on dielectric layer 25. Protective layer 26 is hereinafter described in detail. Protective layer 26 protects dielectric layer 25 from ion collision and improves the electron emission performance and charge retention performance that significantly affect the driving speed. For this purpose, protective layer 26 is formed of base protective layer 26a disposed on dielectric layer 25 and particle layer 26b disposed on base protective layer 26a.

Base protective layer 26a is a thin film layer of magnesium oxide formed by a spattering method, an ion plating method, or an electron beam deposition method, and its thickness is 0.3 to 1.0 μm, for example.

Particle layer 26b is formed by firing a magnesium oxide precursor, and by sticking single crystal particles 27 of magnesium oxide to base protective layer 26a. Here, the single crystal particles have relatively uniform diameter distribution where average diameter is 0.3 to 4 μm. Single crystal particles 27 do not need to be formed so as to cover the whole surface of base protective layer 26a, but are required to be formed on base protective layer 26a in an island shape with a covering ratio of 1% to 30%. The shapes of single crystal particles 27 are basically regular hexahedron or regular octahedron. However, they may be somewhat deformed due to variation or the like in manufacturing, and may be regular hexahedron or regular octahedron having a truncated face and rhombic face provided by cutting its vertex and ridge line.

By forming protective layer 26 of base protective layer 26a and particle layer 26b disposed on base protective layer 26a in this manner, panel 10 having protective layer 26 of high electron emission performance and high charge retention performance can be attained.

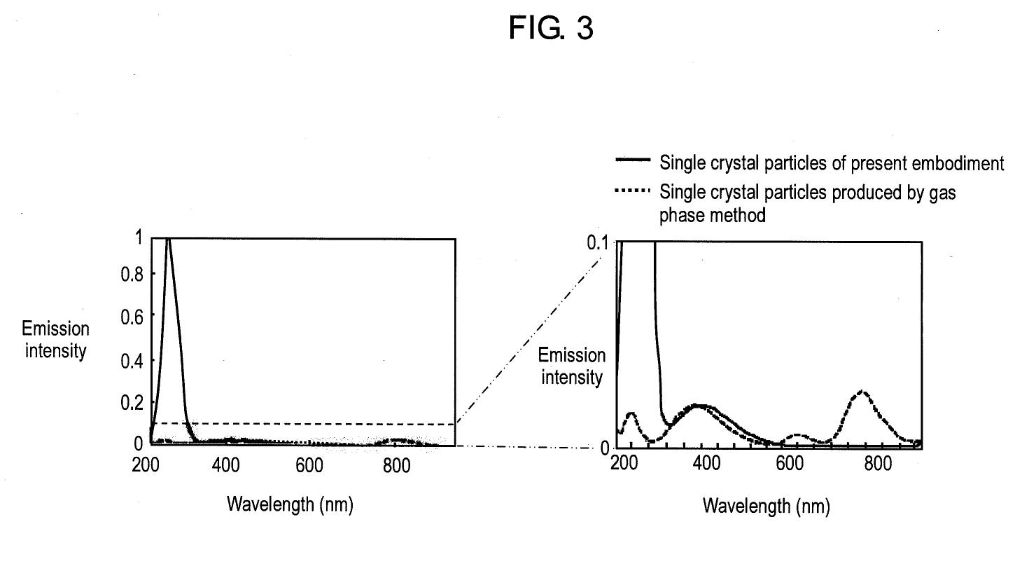

Inventors have investigated the cathode luminescence emission of single crystal particles, and have found that the characteristic of the single crystal particles, specifically, electron emission performance, can be evaluated with the emission spectrum. FIG. 3 is a diagram showing an emission spectrum of single crystal particles 27 of the panel used in accordance with the first exemplary embodiment of the present invention. For comparison purposes, FIG. 3 also shows the emission spectrum of the single crystal particles of magnesium oxide that are produced on the base protective layer by a gas phase oxidation method. The emission spectrum of the emission intensity of single crystal particles 27 in the present embodiment has a high peak at 200 to 300 nm and a low peak at 300 to 550 nm. While, in the emission spectrum of the emission intensity of the single crystal particles produced by the gas phase oxidation method, both peaks at 200 to 300 nm and at 300 to 550 nm are low.

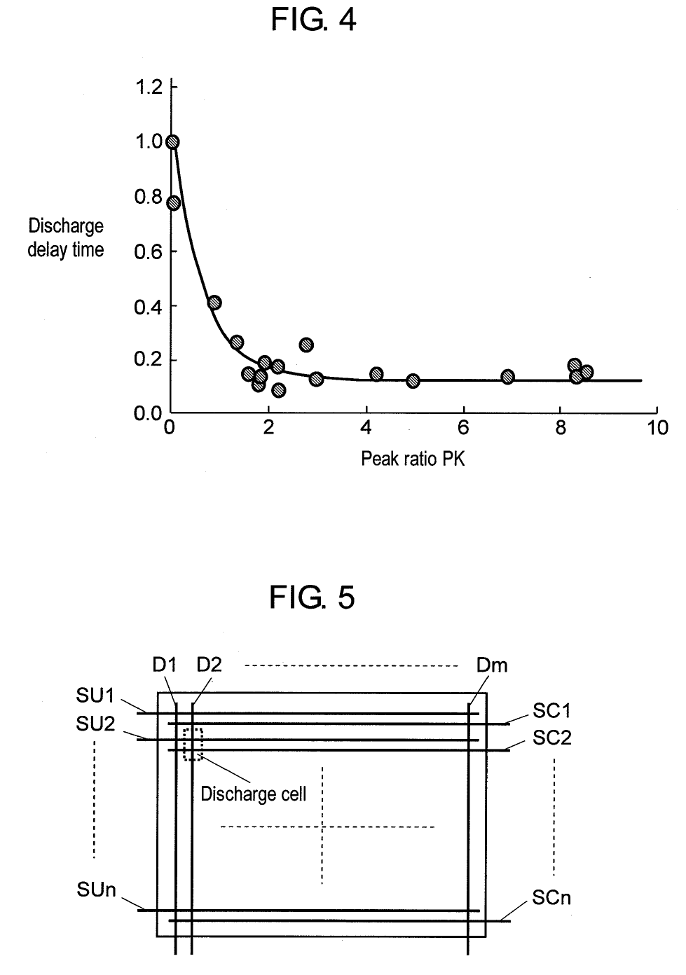

The inventors focus attention on emission intensities at the two peaks. In order to investigate the relation between the electron emission performance and the ratio (hereinafter simply referred to as “peak ratio PK”) of the emission intensity at the peak at 200 to 300 nm to that at 300 to 550 nm, trial panels of different values of peak ratio PK are prepared and the discharge delay time of them is measured. FIG. 4 is a diagram showing the relation between discharge delay time Td and peak ratio PK of the emission spectrum of single crystal particles 27 used in the panel in accordance with the first exemplary embodiment of the present invention. The horizontal axis represents peak ratio PK. Peak ratio PK is determined by calculating the ratio of the integrated value of the emission spectrum in the range of 200 nm or higher and lower than 300 nm to that in the range of 300 nm or higher and lower than 550 nm. The vertical axis represents the value TS obtained by normalizing the discharge delay time with respect to the discharge delay time obtained when the peak ratio PK is about “0”. Therefore, a panel having smaller TS exhibits higher electron emission performance. When peak ratio PK of the emission spectrum is “2” or higher, namely the emission intensity at the peak at 200 to 300 nm is two or more times that at 300 to 550 nm in the emission spectrum of cathode luminescence emission, normalized discharge delay time TS is a substantially constant value of “0.2” or less and high electron emission performance can be obtained.

The relation between the peak ratio PK of the emission spectrum and the electron emission performance is not completely clarified, but the following can be considered. The peak at 200 to 300 nm in the emission spectrum indicates that a reducing process of energy by about 5 eV exists, and also indicates that the probability of Auger electron emission accompanying large energy reduction is high. While, the peak at 300 to 550 nm in the emission spectrum indicates that many trap levels affected by an oxygen defect or the like exist between band gaps and that the significantly reducing process of energy hardly occurs and the probability of Auger electron emission is also low. In other words, when the peak at 200 to 300 nm is higher and the peak at 300 to 550 nm is lower, electrons are more easily emitted. Therefore, forming particle layer 26b using single crystal particles 27 having such a characteristic allows a panel of high electron emission performance to be obtained.

Single crystal particles 27 having a high peak at 200 to 300 nm and a low peak at 300 to 550 nm in the emission spectrum can be produced by a liquid phase method.

Specifically, as described below, single crystal particles 27 can be produced by uniformly firing magnesium hydroxide as a precursor of magnesium oxide in a high-temperature oxygen-containing atmosphere.

(Liquid phase method 1)

Aqueous solution of magnesium alkoxide or magnesium acetylacetone of a purity of 99.95% or higher is hydrolyzed by adding a small amount of acid to it, and gel of magnesium hydroxide is produced. Then, the gel is fired in the air to be dehydrated, thereby producing powder of single crystal particles 27.

(Liquid phase method 2)

Alkaline solution is added to aqueous solution of magnesium nitrate of a purity of 99.95% or higher to precipitate magnesium hydroxide. Then, the precipitate of magnesium hydroxide is separated from the aqueous solution, and is fired in the air to be dehydrated, thereby producing powder of single crystal particles 27.

(Liquid phase method 3)

Calcium hydroxide is added to aqueous solution of magnesium chloride of a purity of 99.95% or higher to precipitate magnesium hydroxide. Then, the precipitate of magnesium hydroxide is separated from the aqueous solution, and is fired in the air to be dehydrated, thereby producing powder of single crystal particles 27.

The firing temperature is preferably 700° C. or higher, more preferably 1000° C. or higher. This is because crystal faces do not sufficiently develop and hence defects increase at a temperature lower than 700° C.

According to the experiment by the inventors, firing at temperature of 700° C. or higher and lower than 2000° C. allows production of two types of single crystal particles;

single crystal particles having a peak ratio PK of “1” or higher; and

single crystal particles that have a peak ratio PK lower than “1” and relatively high peaks in a spectrum range of 680 to 900 nm.

When the firing temperature is 1400° C. or higher, the producing percentage of the single crystal particles that have a peak ratio PK lower than “1” and peaks in an emission spectrum range of 680 to 900 nm increases. Therefore, in order to increase the percentage of single crystal of magnesium oxide having a peak ratio PK of “1” or higher, the firing temperature is preferably set at 700° C. or higher and lower than 1400° C.

As the magnesium oxide precursor, in addition to the above-mentioned magnesium hydroxide, one or more of magnesium alkoxide, magnesium acetylacetone, magnesium nitrate, magnesium chloride, magnesium carbonate, magnesium sulfate, magnesium oxalate, and magnesium acetate can be used. The purity of the magnesium compound as the magnesium oxide precursor is preferably 99.95% or higher, more preferably 99.98% or higher. When many impurity elements such as alkali metal, boron, silicon, iron, and aluminum are contained, fusion or sintering between particles occur during firing, and particles of high crystallinity hardly grow.

The single crystal of magnesium oxide that has a peak ratio PK lower than “1” and peaks in a spectrum range of 680 to 900 nm is apt to have a particle diameter smaller than that of the single crystal of magnesium oxide having a peak ratio PK of “1” or higher. Therefore, these two types of single crystals of magnesium oxide can be separated from each other by classification, and single crystal particles having a high peak ratio PK can be selected.

Thus, particle layer 26b of the present embodiment is formed by sticking, to base protective layer 26a, single crystal particles 27 where the ratio of the peak at 200 to 300 nm to the peak at 300 to 550 nm in the emission spectrum is “2” or higher. The panel that has stably high electron emission performance and charge retention performance and can be driven at high speed is achieved.

Next, a driving method of panel 10 of the present embodiment is described.

FIG. 5 is a diagram showing an electrode array of panel 10 in accordance with the first exemplary embodiment of the present invention. Panel 10 has n scan electrodes SC1 through SCn (scan electrodes 22 in FIG. 1) and n sustain electrodes SU1 through SUn (sustain electrodes 23 in FIG. 1) both long in the row direction (line direction), and m data electrodes D1 through Dm (data electrodes 32 in FIG. 1) long in the column direction. A discharge cell is formed in the part where a pair of scan electrode SCi (i is 1 through n) and sustain electrode SUi intersect with one data electrode Dj is 1 through m). Thus, m×n discharge cells are formed in the discharge space. When the panel is used in a high-definition plasma display device, the number of discharge cells is represented by m=1920×3=5760 and n=1080, for example.

Next, a driving voltage waveform to be applied to each electrode in order to drive panel 10 is described. Panel 10 is driven by a subfield method in which a plurality of subfields are temporally disposed to form one field period. In other words, one field period is divided into the plurality of subfields, and light emission and no light emission of each discharge cell is controlled in each subfield, thereby performing gradation display. Each subfield has an address period and a sustain period. The first subfield has an initializing period.

In the initializing period, initializing discharge is caused to produce, on each electrode, wall charge required for a sustain discharge for causing light emission in the discharge cell. At this time, wall charge required for an address discharge is also produced. In the address period, the address discharge is caused in a discharge cell to emit no light, thereby erasing the wall charge for sustain discharge. In the sustain period, as many sustain pulses as the number corresponding to luminance weight are alternately applied to display electrode pairs, and a sustain discharge is caused in the discharge cell having undergone no address discharge, thereby emitting light.

Thus, the features of the driving method of the present exemplary embodiment are the following:
an initializing period is set in the first subfield and no initializing period is set in the subfields thereafter; and
an address operation is performed in the discharge cell to emit no light.
   In the discharge cell where initializing operation is performed in the initializing period of the first subfield and then address operation is not performed, a sustain discharge is successively caused to emit light. In the discharge cell having undergone the address operation once, no sustain discharge is caused before the next initializing operation. Among the subfield methods, a driving method of displaying gradation by performing control so that the subfields in which the discharge cell undergoes light emission are successively disposed and the subfields in which the discharge cell undergoes no light emission are also successively disposed is hereinafter referred to as “successive driving method”.

In the present exemplary embodiment, one field is divided into 14 subfields (first SF, second SF, . . . , 14th SF). The respective subfields have luminance weights of 1, 1, 1, 1, 3, 5, 5, 8, 16, 16, 20, 22, 28, and 64, for example. The first SF is a subfield that has an initializing period. Each of the second SF through the 14th SF is a subfield that has no initializing period. Hereinafter, the successive driving method of the present exemplary embodiment is described in detail.

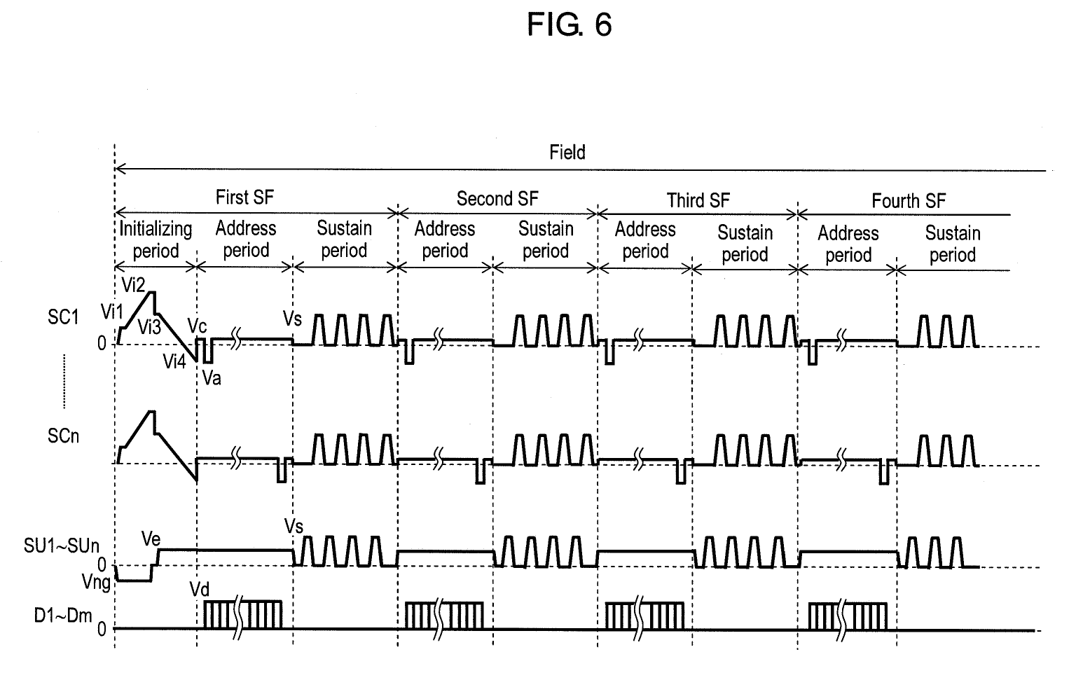

FIG. 6 is a waveform chart of driving voltage applied to each electrode of panel 10 in accordance with the first exemplary embodiment of the present invention. Firstly, the first SF having the initializing period is described.

In the first half of the initializing period of the first SF, 0 (V) is applied to data electrodes D1 through Dm, voltage Vng is applied to sustain electrodes

SU1 through SUn, and ramp waveform voltage is applied to scan electrodes SC1 through SCn. Here, the ramp waveform voltage gradually increases from voltage Vi1 which is not higher than a discharge start voltage, to voltage Vi2, which is higher than the discharge start voltage, with respect to sustain electrodes SU1 through SUn.

While the ramp waveform voltage increases, a feeble initializing discharge occurs between scan electrodes SC1 through SCn and sustain electrodes SU1 through SUn, and a feeble initializing discharge occurs between scan electrodes SC1 through SCn and data electrodes D1 through Dm. Negative wall voltage is accumulated on scan electrodes SC1 through SCn, and positive wall voltage is accumulated on data electrodes D1 through Dm and sustain electrodes SU1 through SUn. Here, the wall voltage on the electrodes represents the voltage generated by the wall charges accumulated on the dielectric layer covering the electrodes, on the protective layer, and on the phosphor layer. In the initializing discharge at this time, excessive wall voltage is accumulated in expectation of optimizing the wall voltage in the subsequent latter half of the initializing period.

In the latter half of the initializing period, voltage Ve is applied to sustain electrodes SU1 through SUn, and ramp waveform voltage is applied to scan electrodes SC1 through SCn. Here, the ramp waveform voltage gradually decreases from voltage Vi3, which is not higher than the discharge start voltage, to voltage Vi4, which is higher than the discharge start voltage, with respect to sustain electrodes SU1 through SUn. While the ramp waveform voltage decreases, a feeble initializing discharge occurs between scan electrodes SC1 through SCn and sustain electrodes SU1 through SUn, and a feeble initializing discharge occurs between scan electrodes SC1 through SCn and data electrodes D1 through Dm. The excessive negative wall voltage on scan electrodes SC1 through SCn and the excessive positive wall voltage on sustain electrodes SU1 through SUn are optimized, and wall charge required for sustain discharge is produced. The excessive positive wall voltage on data electrodes D1 through Dm is also optimized, and the wall charge required for the address discharge is produced. Thus the initializing operation is completed.

In the subsequent address period, voltage Ve is applied to sustain electrodes SU1 through SUn, and voltage Vc is applied to scan electrodes SC1 through SCn.

Next, negative scan pulse voltage Va is applied to scan electrode SC1 in the first line, and positive address pulse voltage Vd is applied to data electrode Dk (k is 1 through m) in the discharge cell to emit no light in the first line, among data electrodes D1 through Dm. At this time, the voltage difference in the intersecting part of data electrode Dk and scan electrode SC1 is derived by adding the difference between the wall voltage on data electrode Dk and that on scan electrode SC1 to the difference (Vd−Va) between the external applied voltages, and exceeds the discharge start voltage. Address discharge thus occurs between data electrode Dk and scan electrode SC1 and between sustain electrode SU1 and scan electrode SC1, and the wall voltage on scan electrode SC1 and the wall voltage on sustain electrode SU1 are erased. The erasing of the wall voltages at this time means that the wall voltages are reduced enough to cause no sustain discharge in the sustain period described later. Negative wall voltage is accumulated on data electrode Dk.

The time since the application of scan pulse voltage Va and address pulse voltage Vd until the occurrence of address discharge is referred to as “discharge delay time”. If the electron emission performance of the panel is low and the discharge delay time is long, the time period when scan pulse voltage Va and address pulse voltage Vd are applied, namely scan pulse width and address pulse width, is required to be set long in order to certainly perform the address operation, and high-speed address operation cannot be performed. If the charge retention performance of the panel is low, the values of scan pulse voltage Va and address pulse voltage Vd are required to be set high in order to compensate for the reduction in wall voltage. However, panel 10 of the present embodiment has high electron emission performance, so that the scan pulse width and address pulse width can be set shorter than those of the conventional panel and high-speed address operation can be stably performed. Panel 10 of the present embodiment has high charge retention performance, so that the values of scan pulse voltage Va and address pulse voltage Vd can be set lower than those of the conventional panel.

Thus, an address operation of causing an address discharge in the discharge cell to emit no light in the first line and erasing wall voltage on each electrode is performed. The voltage in the part where scan electrode SC1 intersects with data electrodes D1 through Dm applied with no address pulse voltage Vd does not exceed the discharge start voltage. Therefore, an address discharge does not occur and the wall voltage at the completion of the initializing period is maintained. This address operation is repeated until it reaches the discharge cell in the n-th line, and the address period is completed.

In the subsequent sustain period, firstly, 0 (V) is applied to scan electrodes SC1 through SCn, and positive sustain pulse voltage Vs is applied to sustain electrodes SU1 through SUn. In the discharge cell having undergone no address discharge, the voltage difference between sustain electrode SUi and scan electrode SCi is obtained by adding the difference between the wall voltage on sustain electrode SUi and that on scan electrode SCi to sustain pulse voltage Vs, and exceeds the discharge start voltage.

A sustain discharge occurs between scan electrode SCi and sustain electrode SUi, and ultraviolet rays generated at this time cause phosphor layer 35 to emit light. Positive wall voltage is accumulated on scan electrode SCi, and negative wall voltage is accumulated on sustain electrode SUi. In the discharge cell having undergone address discharge in the address period, sustain discharge does not occur.

Subsequently, sustain pulse voltage Vs is applied to scan electrodes SC1 through SCn, and 0 (V) is applied to sustain electrodes SU1 through SUn. In the discharge cell having undergone the sustain discharge, the voltage difference between scan electrode SCi and sustain electrode SUi exceeds the discharge start voltage. Therefore, a sustain discharge occurs between scan electrode SCi and sustain electrode SUi again, negative wall voltage is accumulated on scan electrode SCi, and positive wall voltage is accumulated on sustain electrode SUi.

Hereinafter, similarly, as many sustain pulses as the number corresponding to the luminance weight are alternately applied to sustain electrodes SU1 through SUn and scan electrodes SC1 through SCn to apply potential difference between the electrodes of the display electrode pairs. Thus, a sustain discharge is successively performed in the discharge cell having undergone no address discharge in the address period.

The subsequent second SF is a subfield that has no initializing period. In the address period of the second SF, voltage Ve is applied to sustain electrodes SU1 through SUn, and voltage Vc is applied to scan electrodes SC1 through SCn. Then, negative scan pulse Va is applied to scan electrode SC1 in the first line, and positive address pulse voltage Vd is applied to data electrode Dk in a discharge cell to emit no light in the first line, among data electrodes D1 through Dm.

Then, in the discharge cell having undergone sustain discharge in the immediately preceding first SF, an address discharge occurs between data electrode Dk and sustain electrode SC1 and between sustain electrode SU1 and scan electrode SC1, and the wall voltage on scan electrode SC1 and the wall voltage on sustain electrode SU1 are erased. Thus, an address operation of causing an address discharge in the discharge cell to emit no light in the first line and erasing the wall voltage on each electrode is performed. While, the voltage in the parts where data electrodes D1 through Dm intersect with scan electrode SC1 does not exceed the discharge start voltage and hence address discharge does not occur in the following discharge cells:
a discharge cell having undergone an address discharge in the address period after the initializing period and having undergone no sustain discharge in the immediately preceding first SF; and
a discharge cell having been applied with no address pulse voltage Vd.
   The above-mentioned address operation is repeated until the operation reaches the discharge cell in the n-th line, and the address period is completed.

In the subsequent sustain period, 0 (V) is applied to scan electrodes SC1 through SCn, and positive sustain pulse voltage Vs is applied to sustain electrodes SU1 through SUn. Then, in the discharge cell having undergone a sustain discharge and having undergone no address discharge in the sustain period of the immediately preceding first SF, a sustain discharge occurs between scan electrode SCi and sustain electrode SUi. Thus light is emitted in the corresponding cell. In the discharge cell having undergone an address discharge in the address period after the initializing period and having undergone no sustain discharge in the immediately preceding first SF, or in the discharge cell having undergone an address discharge, sustain discharge does not occur.

Subsequently, sustain pulse voltage Vs is applied to scan electrodes SC1 through SCn, and 0 (V) is applied to sustain electrode SU1 through SUn. Then, in the discharge cell having undergone sustain discharge, sustain discharge occurs again, hence positive wall voltage is accumulated on sustain electrode SUi, and negative wall voltage is accumulated on scan electrode SCi. Thereafter, similarly, as many sustain pulses as the number corresponding to luminance weight are alternately applied to sustain electrodes SU1 through SUn and scan electrodes SC1 through SCn, thereby applying potential difference between the electrodes of each display electrode pair. Thus, the sustain discharge is successively performed.

The driving voltage waveforms and the operation of the panel in the third SF through the 14th SF are substantially similar to those in the second SF except for the number of sustain pulses.

In other words, in the address periods in the third SF through the 14th SF, voltage Ve is applied to sustain electrodes SU1 through SUn, and voltage Vc is applied to scan electrodes SC1 through SCn. Then, negative scan pulse Va is applied to scan electrode SC1 in the first line, and positive address pulse voltage Vd is applied to data electrode Dk in the discharge cell to emit no light in the first line, among data electrodes D1 through Dm.

Then, in the discharge cell having undergone sustain discharge in the immediately preceding subfield, an address discharge occurs, and the wall voltage on scan electrode SC1 and the wall voltage on sustain electrode SU1 are erased. While, in the discharge cell having undergone address discharge in the address period after the initializing period and having undergone no sustain discharge in the immediately preceding subfield, and in the discharge cell having been applied with no address pulse Vd, no address discharge occurs. The above-mentioned address operation is repeated until the operation reaches the discharge cell in the n-th line, and the address period is completed.

In the subsequent sustain period, as many sustain pulses as the number corresponding to luminance weight are alternately applied to sustain electrodes SU1 through SUn and scan electrodes SC1 through SCn. Then, in the discharge cell having undergone a sustain discharge and having undergone no address discharge in the sustain period in the immediately preceding subfield, a sustain discharge occurs and thus light is emitted. While, in the discharge cell having undergone an address discharge in the address period after the initializing period and having undergone no sustain discharge in the immediately preceding subfield, or in the discharge cell having undergone an address discharge, no sustain discharge occurs.

In the present exemplary embodiment, voltage Vi1 applied to scan electrodes SC1 through SCn is 130 (V), voltage Vi2 is 380 (V), voltage Vi3 is 200 (V), voltage Vi4 is −25 (V), voltage Vc is 80 (V), voltage Va is −50 (V), and voltage Vs is 200 (V). Voltage Vng applied to sustain electrodes SU1 through SUn is −50 (V), voltage Ve is 50 (V), and voltage Vs is 200 (V). Voltage Vd applied to data electrodes D1 through Dm is 67 (V). The gradient of the up-ramp waveform voltage applied to scan electrodes SC1 through SCn is 1.0 V/μ, and the gradient of the down-ramp waveform voltage is −1.3 V/μ. Each of the pulse width of the scan pulse and the pulse width of the address pulse is 1.0 μs. However, these voltage values are not limited to the above-mentioned values. It is preferable to set optimum values according to the discharge characteristic of the panel and the specification of the plasma display device.

As described above, the driving method of the present exemplary embodiment is a successive driving method. That is, in the discharge cell where initializing operation is performed in the initializing period of the first subfield and then address operation is not performed, a sustain discharge is successively caused to emit light. In the discharge cell having undergone an address operation once, a sustain discharge is not caused before the next initializing operation.

Thus, in the present exemplary embodiment, panel 10 is driven by the successive driving method in the following conditions:
the address period is shortened using the performance of panel 10 that has high electron emission performance and can be driven at high speed; and
the number of subfields required for gradation display is secured.
   Therefore, a high-quality image having no false contour can be displayed.

Panel 10 of the present exemplary embodiment has high charge retention performance, so that the values of scan pulse voltage Va and address pulse voltage Vd can be set lower than those of the conventional panel. Even in panel 10 of the present exemplary embodiment, however, the wall charge slightly decreases. Therefore, as the number of discharge electrode pairs is increased or the number of subfields is increased, the values of scan pulse voltage Va and address pulse voltage Vd are apt to increase. Next, the successive driving method for suppressing the voltage increase is described.

### Second Exemplary Embodiment

The structure of the panel of the second exemplary embodiment of the present invention is the same as that of panel 10 of the first exemplary embodiment, and thus the description thereof is omitted. The second exemplary embodiment largely differs from the first exemplary embodiment in the driving method of panel 10. In other words, in a successive driving method of the second exemplary embodiment, the increase of scan pulse voltage Va and address pulse voltage Vd is suppressed.

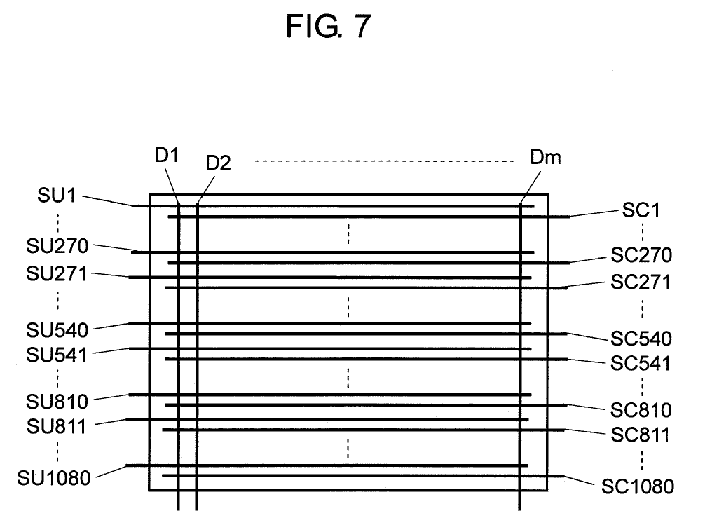

FIG. 7 is a diagram showing an electrode array of panel 10 in accordance with a second exemplary embodiment of the present invention. The electrode array of panel 10 is identical with that in the first exemplary embodiment. In other words, panel 10 has n scan electrodes SC1 through SCn (scan electrodes 22 in FIG. 1) and n sustain electrodes SU1 through SUn (sustain electrodes 23 in FIG. 1) both long in the row direction (line direction), and m data electrodes D1 through Dm (data electrodes 32 in FIG. 1) long in the column direction. A discharge cell is formed in the part where a pair of scan electrode SCi is 1 through n) and sustain electrode SUi intersect with one data electrode Dj (j is 1 through m). Thus, m×n discharge cells are formed in the discharge space. The number of discharge cells is represented by m=1920×3=5760 and n=1080, for example. The number of display electrode pairs is not limited specifically, but the second exemplary embodiment is described assuming n=1080.

Then, 1080 display electrode pairs formed of n scan electrodes SC1 through SC1080 and n sustain electrodes SU1 through SU1080 are classified into a plurality of display electrode pair groups. In the description of the second exemplary embodiment, the panel is vertically divided into four display electrode pair groups. The four groups are referred to as a first display electrode pair group, a second display electrode pair group, a third display electrode pair group, and a fourth display electrode pair group in the order starting from the display electrode pair that is disposed at the top of the panel. In other words, 270 scan electrodes SC1 through SC270 and 270 sustain electrodes SU1 through SU270 belong to the first display electrode pair group. Other 270 scan electrodes SC271 through SC540 and 270 sustain electrodes SU271 through SU540 belong to the second display electrode pair group. Other 270 scan electrodes SC541 through SC810 and 270 sustain electrodes SU541 through SU810 belong to the third display electrode pair group. The other 270 scan electrodes SC811 through SC1080 and 270 sustain electrodes SU811 through SU1080 belong to the fourth display electrode pair group.

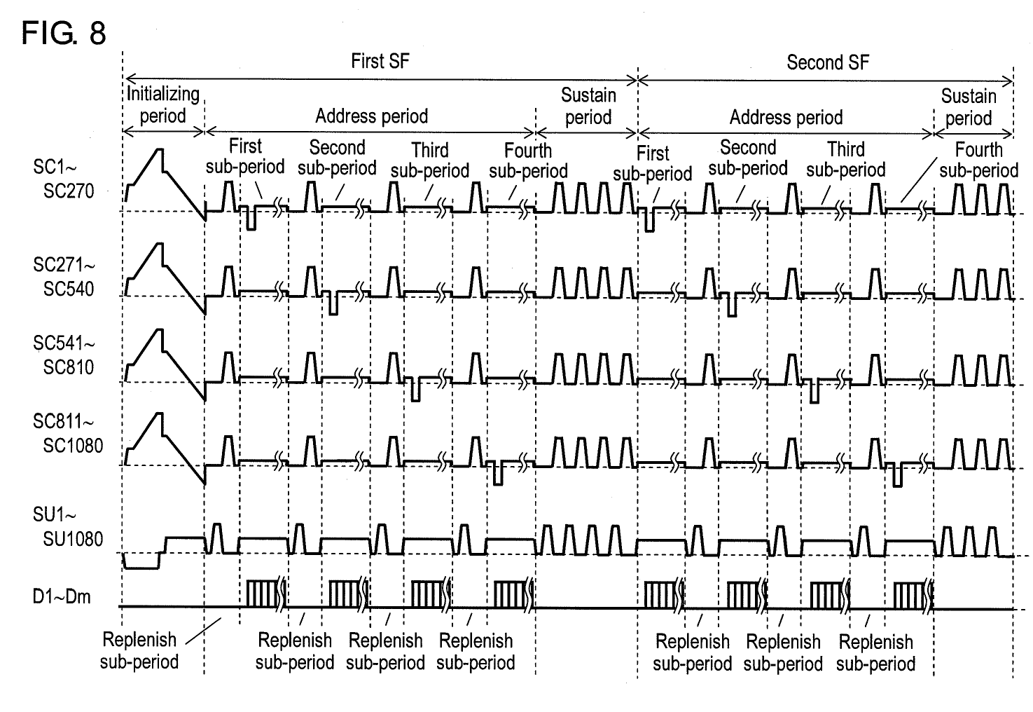

FIG. 8 is a waveform chart of driving voltage applied to each electrode of panel 10 in accordance with the second exemplary embodiment. FIG. 8 shows the first SF and the second SF.

The initializing period of the first SF is similar to that of the first exemplary embodiment, and thus the description thereof is omitted.

In the subsequent address period, the address period is divided into four address sub-periods (first sub-period, second sub-period, third sub-period, and fourth sub-period) corresponding to the four display electrode pair groups, and a replenish sub-period for replenishing wall charge is disposed before each address sub-period.

In the first replenish sub-period in the address period, firstly, 0 (V) is applied to scan electrodes SC1 through SCn, and positive sustain pulse voltage Vs is applied to sustain electrodes SU1 through SUn. Discharge then occurs between scan electrode SCi and sustain electrode SUi. Sequentially, sustain pulse voltage Vs is applied to scan electrodes SC1 through SCn, and 0 (V) is applied to sustain electrodes SU1 through SUn. A discharge then occurs between scan electrode SCi and sustain electrode SUi again. The discharge (hereinafter referred to as “replenish discharge”) in the replenish sub-period is similar to the sustain discharge, and occurs independently of image display. If the wall charge on data electrodes D1 through Dm is reduced by some causes, the wall charge on data electrodes Dl through Dm is a replenished by replenish discharge. Therefore, the values of scan pulse voltage Va and address pulse voltage Vd do not increase in the subsequent first sub-period.

In the subsequent address sub-period, namely the first sub-period, voltage Ve is applied to sustain electrodes SU1 through SUn, and voltage Vc is applied to scan electrodes SC1 through SCn. Then, scan pulse voltage Va is applied to scan electrode SC1 in the first line, and address pulse voltage Vd is applied to data electrode Dk in the discharge cell to emit no light in the first line, among data electrodes D1 through Dm. Address discharge then occurs between data electrode Dk and scan electrode SC1 and between sustain electrode SU1 and scan electrode SC1, and hence the wall voltage on scan electrode SC1 and the wall voltage on sustain electrode SU1 are erased. The above-mentioned address operation is repeated until the operation reaches the discharge cell in the 270th line, which belongs to the first display electrode pair group, and the first sub-period is completed.

In the subsequent replenish sub-period, first, 0 (V) is applied to scan electrodes SC1 through SCn, and positive sustain pulse voltage Vs is applied to sustain electrodes SU1 through SUn to cause replenish discharge. Then, sustain pulse voltage Vs is applied to scan electrodes SC1 through SCn, and 0 (V) is applied to sustain electrodes SU1 through SUn to cause replenish discharge. The number of discharge cells undergoing address operation in the first sub-period is ¼ of the total number of discharge cells. Therefore, the amount of decreasing wall charge is about ¼ times the amount of decreasing wall charge in the address period in the driving method of the first exemplary embodiment. However, before wall charge further decreases, the wall charge on data electrodes D1 through Dm is replenished by the replenish discharge. Therefore, in the subsequent second sub-period, the values of scan pulse voltage Va and address pulse voltage Vd do not increase.

In the subsequent address sub-period, namely the second sub-period, voltage Ve is applied to sustain electrodes SU1 through SUn, and voltage Vc is applied to scan electrodes SC1 through SCn. Then, scan pulse voltage Va is applied to scan electrode SC271 in the 271st line, and address pulse voltage Vd is applied to data electrode Dk in the discharge cell to emit no light in the 271st line, among data electrodes D1 through Dm. An address discharge then occurs, and hence the wall voltage on scan electrode SC271 and the wall voltage on sustain electrode SU271 are erased. The above-mentioned address operation is repeated in the discharge cells in the 271st line to the 540th line, which belong to the second display electrode pair group, and the second sub-period is completed.

In the subsequent replenish sub-period, firstly, 0 (V) is applied to scan electrodes SC1 through SCn, and positive sustain pulse voltage Vs is applied to sustain electrodes SU1 through SUn to cause replenish discharge. Then, sustain pulse voltage Vs is applied to scan electrodes SC1 through SCn, and 0 (V) is applied to sustain electrodes SU1 through SUn to cause replenish discharge. The number of discharge cells undergoing the address operation in the second sub-period is also ¼ of the total number of discharge cells. Therefore, the amount of decreasing wall charge is also about ¼ times the amount of decreasing wall charge in the address period in the driving method of the first exemplary embodiment. However, before wall charge further decreases, the wall charge on data electrodes D1 through Dm is replenished by the replenish discharge. Therefore, in the subsequent third sub-period, the values of scan pulse voltage Va and address pulse voltage Vd do not increase.

In the subsequent third sub-period, voltage Ve is applied to sustain electrodes SU1 through SUn, and voltage Vc is applied to scan electrodes SC1 through SCn. Then, scan pulse voltage Va is applied to scan electrode SC541 in the 541st line, and address pulse voltage Vd is applied to data electrode Dk in the discharge cell to emit no light in the 541st line, among data electrodes D1 through Dm. An address discharge then occurs, and hence the wall voltage on scan electrode SC541 and the wall voltage on sustain electrode SU541 are erased. The above-mentioned address operation is repeated in the discharge cells in the 541st line to the 810th line, which belong to the third display electrode pair group, and the third sub-period is completed.

In the subsequent replenish sub-period, similarly to the other replenish sub-periods, firstly, 0 (V) is applied to scan electrodes SC1 through SCn, and positive sustain pulse voltage Vs is applied to sustain electrodes SU1 through SUn to cause replenish discharge. Then, sustain pulse voltage Vs is applied to scan electrodes SC1 through SCn, and 0 (V) is applied to sustain electrodes SU1 through SUn to cause replenish discharge.

In the fourth sub-period, voltage Ve is applied to sustain electrodes SU1 through SUn, and voltage Vc is applied to scan electrodes SC1 through SCn. Then, scan pulse voltage Va is applied to scan electrode SC811 in the 811st line, and address pulse voltage Vd is applied to data electrode Dk in the discharge cell to emit no light in the 811st line, among data electrodes D1 through Dm. An address discharge then occurs, and hence the wall voltage on scan electrode SC811 and the wall voltage on sustain electrode SU811 are erased. The above-mentioned address operation is repeated in the discharge cells in the 811st line to the 1,080th line, which belong to the fourth display electrode pair group. Thus the address period is completed.

The sustain period of the first SF is similar to that of the first exemplary embodiment, and therefore the description thereof is omitted.

In the address period of the second SF, the address period is divided into four address sub-periods (first sub-period, second sub-period, third sub-period, and fourth sub-period) corresponding to the four display electrode pair groups, and a replenish sub-period for replenishing wall charge is disposed before each address sub-period. However, the sustain discharge in the sustain period of the first SF can be substituted for the replenish discharge before the first sub-period, so that the replenish discharge is omitted in the second exemplary embodiment. The other sub-periods, namely the first sub-period, the replenish sub-period, the second sub-period, the replenish sub-period, the third sub-period, the replenish sub-period, and the fourth sub-period, are similar to the first sub-period, the replenish sub-period, the second sub-period, the replenish sub-period, the third sub-period, the replenish sub-period, and the fourth sub-period in the first SF, respectively.

The sustain period of the second SF is similar to that of the first exemplary embodiment, and thus the description thereof is omitted. The sustain periods of the third SF through the 14th SF are similar to that of the second SF except for the numbers of sustain pulses.

In the second exemplary embodiment, thus, panel 10 is driven in the following processes:
classifying display electrode pairs 24 into four display electrode pair groups;
dividing the address period into four address sub-periods corresponding to the four display electrode pair groups;
disposing a replenish sub-period for replenishing wall charge before each address sub-period; and
driving panel 10.
   Therefore, the number of discharge cells undergoing the address operation in each address sub-period is ¼ of the total number of discharge cells, and the amount of decreasing wall charge is also about ¼ times the amount of decreasing wall charge in the address period in the driving method of the first exemplary embodiment. Before wall charge further decreases, the wall charge on data electrodes D1 through Dm is replenished by the replenish discharge. Therefore, in each subsequent sub-period, the values of scan pulse voltage Va and address pulse voltage Vd do not increase. As a result, voltage increase can be suppressed.

In the second exemplary embodiment, thus, panel 10 is driven in the following processes:
classifying display electrode pairs 24 into four display electrode pair groups;
dividing the address period into four address sub-periods corresponding to the four display electrode pair groups;
disposing a replenish sub-period for replenishing wall charge before each address sub-period in the first SF;
disposing a replenish sub-period for replenishing wall charge before each address sub-period except the first sub-period, in the second SF through 14th SF; and
driving panel 10.
   However, the present invention is not limited to this. Simply, the panel may be driven in the following processes:
classifying display electrode pairs 24 into a plurality of display electrode pair groups dependently on the characteristic or the like of the panel;
dividing the address period into a plurality of address sub-periods corresponding to the plurality of display electrode pair groups;
disposing a replenish sub-period for replenishing wall charge before at least one address sub-period; and
driving the panel.

In the description of the second exemplary embodiment, the first display electrode pair group undergoes an address operation in the first sub-period, the second display electrode pair group undergoes it in the second sub-period, the third display electrode pair group undergoes it in the third sub-period, and the fourth display electrode pair group undergoes it in the fourth sub-period. However, the present invention is not limited to this. In order to uniform the display luminances of respective display electrode pair groups, it is preferable to change the combination of the display electrode pair groups and the address sub-periods every times the field changes. For example, in the first field, the first display electrode pair group undergoes an address operation in the first sub-period, the second display electrode pair group undergoes it in the second sub-period, the third display electrode pair group undergoes it in the third sub-period, and the fourth display electrode pair group undergoes it in the fourth sub-period. In the second field, the first display electrode pair group undergoes an address operation in the second sub-period, the second display electrode pair group undergoes it in the third sub-period, the third display electrode pair group undergoes it in the fourth sub-period, and the fourth display electrode pair group undergoes it in the first sub-period. In the third field, the first display electrode pair group undergoes an address operation in the third sub-period, the second display electrode pair group undergoes it in the fourth sub-period, the third display electrode pair group undergoes it in the first sub-period, and the fourth display electrode pair group undergoes it in the second sub-period. In the fourth field, the first display electrode pair group undergoes an address operation in the fourth sub-period, the second display electrode pair group undergoes it in the first sub-period, the third display electrode pair group undergoes it in the second sub-period, and the fourth display electrode pair group undergoes it in the third sub-period. Thus, the combination of the display electrode pair groups and the address sub-periods is cylindrically changed every times the field changes, thereby uniforming the display luminances of respective display electrode pair groups.

Next, one example of the driving circuits for generating the driving voltage waveforms having been described in the first exemplary embodiment and the second exemplary embodiment is described.

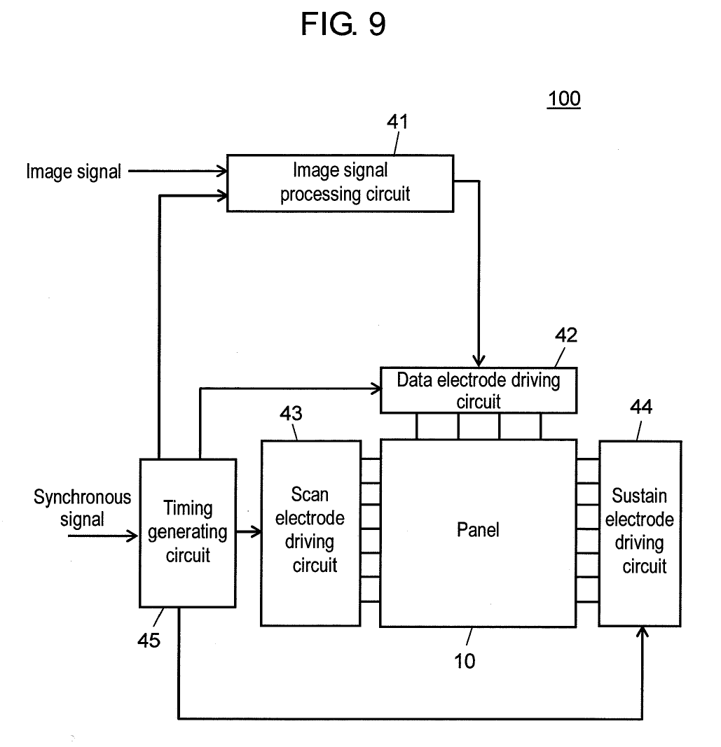

FIG. 9 is a circuit block diagram of plasma display device 100 in accordance with the first and second exemplary embodiments of the present invention. Plasma display device 100 has panel 10 and a panel driving circuit. Protective layer 26 of panel 10 has base protective layer 26a and particle layer 26b. Base protective layer 26a is formed of a thin film of metal oxide containing at least one of magnesium oxide, strontium oxide, calcium oxide, and barium oxide. Particle layer 26b is formed by sticking single crystal particles 27 of magnesium oxide to base protective layer 26a. Here, in single crystal particles 27, the ratio of the peak at 200 to 300 nm to the peak at 300 to 550 nm in the cathode luminescence emission spectrum is 2 or higher. The panel driving circuit drives panel 10 by the following processes:
causing initializing discharge for producing the wall charge required for sustain discharge in the first subfield, of a plurality of subfields;
causing address discharge for erasing the wall charge required for sustain discharge in the address periods of the plurality of subfields; and
driving the panel.
   The panel driving circuit has the following elements:
panel 10;
image signal processing circuit 41;
data electrode driving circuit 42;
scan electrode driving circuit 43;
sustain electrode driving circuit 44;
timing generating circuit 45; and
a power supply circuit (not shown) for supplying power required for each circuit block.

Image signal processing circuit 41 converts an input image signal into image data that indicates light emission or no light emission in each subfield. Data electrode driving circuit 42 converts the image data in each subfield into a signal corresponding to each of data electrodes D1 through Dm, and drives each of data electrodes D1 through Dm. Timing generating circuit 45 generates various timing signals for controlling operations of respective circuit blocks based on a horizontal synchronizing signal and a vertical synchronizing signal, and supplies them to respective circuit blocks. Scan electrode driving circuit 43 drives each of scan electrodes SC1 through SCn based on a timing signal, and sustain electrode driving circuit 44 drives sustain electrodes SU1 through SUn based on a timing signal.

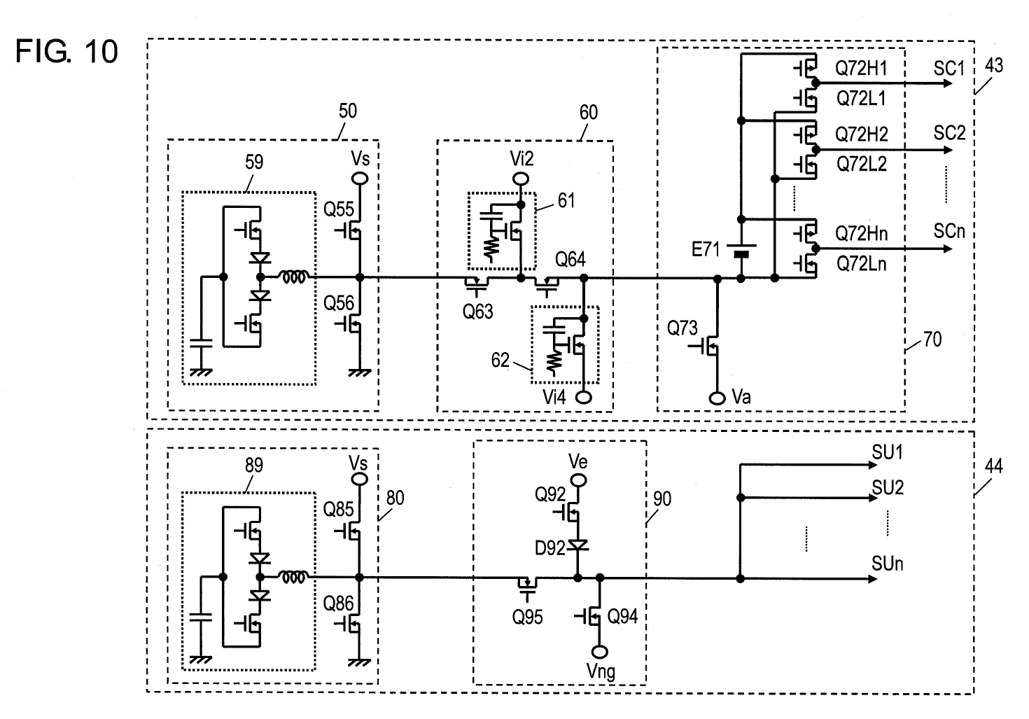

FIG. 10 is a circuit diagram of scan electrode driving circuit 43 and sustain electrode driving circuit 44 of plasma display device 100 in accordance with the first and second exemplary embodiments of the present invention.

Scan electrode driving circuit 43 has sustain pulse generating circuit 50, initializing waveform generating circuit 60, and scan pulse generating circuit 70. Sustain pulse generating circuit 50 has the following elements:
switching element Q55 for applying voltage Vs to scan electrodes SC1 through SCn;
switching element Q56 for applying 0 (V) to scan electrodes SC1 through SCn;
electric power recovering section 59 for recovering electric power when a sustain pulse is applied to scan electrodes SC1 through SCn.
   Initializing waveform generating circuit 60 has Miller integrating circuit 61 for applying up-ramp waveform voltage to scan electrodes SC1 through SCn, and Miller integrating circuit 62 for applying down-ramp waveform voltage to scan electrodes SC1 through SCn. Switching element Q63 and switching element Q64 prevent current from flowing backward through a parasitic diode or the like of another switching element. Scan pulse generating circuit 70 has the following elements:
floating power supply E71;
switching elements Q72H1 through Q72Hn and Q72L1 through Q72Ln for applying voltage on the high voltage side of floating power supply E71 or voltage on the low voltage side thereof to respective scan electrodes SC1 through SCn; and
switching element Q73 for fixing the voltage on the low voltage side of floating power supply E71 to voltage Va.

Sustain electrode driving circuit 44 has sustain pulse generating circuit 80, and initializing/address voltage generating circuit 90. Sustain pulse generating circuit 80 has the following elements:
switching element Q85 for applying voltage Vs to sustain electrodes SU1 through SUn;
switching element Q86 for applying 0 (V) to sustain electrodes SU1 through SUn; and
electric power recovering section 89 for recovering electric power when a sustain pulse is applied to sustain electrodes SU1 through SUn.
   Initializing/address voltage generating circuit 90 has the following elements:
switching element Q92 and diode D92 for applying voltage Ve to sustain electrodes SU1 through SUn; and
switching element Q94 for applying voltage Vng to sustain electrodes SU1 through SUn.
   Switching element Q95 prevents current from flowing backward through a parasitic diode or the like of another switching element.

These switching elements can be formed of generally known elements such as a metal oxide semiconductor field effect transistor (MOSFET) and an insulated gate bipolar transistor (IGBT). Each of these switching elements is controlled by a timing signal corresponding to the switching element generated by timing generating circuit 45.

The driving circuit shown in FIG. 10 is an example of circuitry for generating the driving voltage waveform of FIG. 6. The plasma display device of the present invention is not limited to this circuitry.

Each of the specific numerical values used in the first and second embodiments is simply one example. Preferably, they are set to optimal values appropriately in response to the characteristic of the panel and the specification of the plasma display device.

### INDUSTRIAL APPLICABILITY

The plasma display device of the present invention performs high-speed and stable address operation and can display an image of high display quality. Therefore, this plasma display device can be used as a display device.

1. A plasma display device comprising:
a plasma display panel including:
a front plate having display electrode pairs on a first glass substrate, a dielectric layer for covering the display electrode pairs, and a protective layer on the dielectric layer;
a back plate having data electrodes on a second glass substrate, the back plate being faced to the front plate; and
discharge cells formed at positions where the display electrode pairs face the data electrodes; and
a panel driving circuit for driving the plasma display panel while a plurality of subfields are temporally disposed to form one field period, each of the subfields having an address period for causing an address discharge and a sustain period for causing a sustain discharge in the discharge cells,
wherein the protective layer has:
a base protective layer formed of a thin film of metal oxide containing at least one of magnesium oxide, strontium oxide, calcium oxide, and barium oxide; and
a particle layer formed by sticking single crystal particles of magnesium oxide to the base protective layer, wherein, in the single crystal particles, the emission intensity at the peak at 200 to 300 nm is two or more times that at 300 to 550 nm in a cathode luminescence emission spectrum, and
wherein the panel driving circuit
causes an initializing discharge for producing wall charge in a first subfield, of the plurality of subfields,
causes an address discharge for erasing wall charge in address periods of the plurality of subfields, and
drives the plasma display panel.

2. The plasma display device of claim 1, wherein
the panel driving circuit
classifies the display electrode pairs into a plurality of display electrode pair groups,
divides the address period into a plurality of address sub-periods correspondingly to the plurality of display electrode pair groups,
disposes a replenish sub-period for replenishing wall charge between one address sub-period and a next address sub-period, and
drives the plasma display panel.
